(19) United States
(12) Patent Application Publication
(10) Pub. No.: US 2009/0064826 A1
(43) Pub. Date: Mar. 12, 2009

(54) LOCKING PLIERS FOR CONTROLLED MANIPULATION

(76) Inventor: Thomas M. Robert, Williams, IA (US)

Correspondence Address: PATWRITE LLC, 408 W. MAIN ST., MARSHALLTOWN, IA, 50158-5759, US

(21) Appl. No.: 12/267,718

(22) Filed: Nov. 10, 2008

Related U.S. Application Data
(63) Continuation-in-part of application No. 11/530,538, filed on Sep. 11, 2006.
(60) Provisional application No. 60/986,739, filed on Nov. 9, 2007.

(51) Int. Cl. B25B 7/16; B25B 7/22

(52) U.S. Cl. 81/399; 81/318; 81/489; 81/488; 7/125; 7/168

(57) ABSTRACT

An improved locking pliers is provided with an attachment member having a threaded aperture fixed on the handle of the locking pliers. In one embodiment, the attachment member is in the form of a coupling nut or other extended wide nut welded to the handle. In another embodiment, the attachment member is integrally formed as part of the handle during the manufacture of the pliers. In another embodiment, the attachment member is concentrically attached to the end of the handle so that a pulling, pushing or twisting force is applied along the plane of the handle without torque. The attachment member does not interfere with the normal locking operation or any other normal operation of the pliers. In another embodiment, a quick connection attachment member, such as a locking pin or quick disconnect joint, is used in place of a threaded portion.

### RELATED APPLICATIONS

This is a continuation in part of U.S. patent application Ser. No. 11/530,538, filed Sep. 11, 2006 and claims priority to Provisional Application Ser. No. 60/986,739, filed on Nov. 9, 2007, the complete disclosures of each of which are hereby incorporated by reference.

### BACKGROUND OF THE INVENTION

The present invention relates to locking pliers or wrenches. Specifically, the present invention relates to improved locking pliers or wrenches for the controlled manipulations of loads.

Various types of locking pliers are well known to those ordinarily skilled in the art and have been around for many years. Such locking pliers generally operate using an over-center toggle linkage that closes and locks a movable jaw in an adjustable position with respect to a fixed jaw. Once the toggle linkage or fulcrum bar has been closed to an over center location, the opposing jaws of the locking pliers remain locked onto the object.

There are many instances when a user needs to use locking pliers to manipulate a load or to use the locking pliers as a third hand while retaining the ability to use the locking pliers conventionally. There is a need for a locking pliers that is able to be used to manipulate a load while also being used in a conventional manner that overcomes the limitations of the prior art.

### SUMMARY OF THE INVENTION

An improved locking pliers is provided with an attachment member having a threaded aperture fixed on the handle of the locking pliers. In one embodiment, the attachment member is in the form of a coupling nut or other extended wide nut welded to the handle. In another embodiment, the attachment member is integrally formed as part of the handle during the manufacture of the pliers. In another embodiment, the attachment member is concentrically attached to the end of the handle so that a pulling, pushing or twisting force is applied along the plane of the handle without torque. The attachment member does not interfere with the normal locking operation or any other normal operation of the pliers. In another embodiment, a quick connection attachment member, such as a locking pin or quick disconnect joint, is used in place of a threaded portion.

Other features and advantages of the instant invention will become apparent from the following description of the invention which refers to the accompanying drawings.

### BRIEF DESCRIPTION OF THE DRAWINGS

FIG. 1 is a perspective view of the improved locking pliers of the present invention.

FIG. 2 is a side elevation view of the improved locking pliers shown in FIG. 1.

FIG. 3 is a perspective view of an alternative embodiment of the improved locking pliers of the present invention.

FIG. 4 is a plan view of a blank used in forming the handle of the locking pliers shown in FIG. 3.

FIG. 5 is a side elevation view of another embodiment of the improved locking pliers of the present invention.

FIG. 6 is a side elevation view showing the locking pliers gripped to an overhead beam with a load applied via the attachment member, in accordance with the present invention.

FIG. 7 is an enlarged view taken along lines 7-7 of FIG. 1.

FIG. 8 is a view showing an indicia for an original equipment manufacturer of the improved locking pliers.

FIG. 9 is a view showing tandem or lateral connection of four pliers equipped with the present invention and connected to a wide load.

FIG. 10 is a view showing a pair of pliers according to the present invention used in tandem to hold a load.

FIG. 11 is a perspective view of an embodiment of the locking pliers of the present invention.

FIG. 12 is a perspective view of an embodiment of the locking pliers of the present invention.

FIG. 13 is a perspective view of an embodiment of the locking pliers of the present invention.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

The locking pliers of the present invention are generally designated by the reference numeral 10 in the drawings. The pliers 10 include a handle 12 with a fixed jaw 14 at the forward end and a threaded sleeve 16 at the rearward end. The handle 12 is generally formed from a flat blank or plate which is bent into a U shape having opposite side walls 18. The sleeve 16 is formed by opposite edges of the plate being wrapped around to meet at a seam 17. A pivot pin 20 extends between the side walls 18 of the handle 12. The fixed jaw 14 is welded to the enlarged wings or flanges 22 of the handle 12 after the handle is formed.

A moveable jaw 24 is pivotally connected to the handle 12 by pin 20. A lever 28 is pivotally connected to the moveable jaw 24 via a pivot pin 26. The lever 28 has a U-shaped construction with opposite side walls 32 between which the moveable jaw 24 extends. A fulcrum bar 34 extends between the opposite sides 32 of the lever 28 and is pivotally connected thereto by a pin 30. The opposite end of the fulcrum bar 34 is received between the side walls 18 of the handle 12 adjacent the rearward end thereof, so as to be in contact with a threaded shank 36 matingly received in the threaded sleeve 16. The shank 36 has a knurled end or knob 37 for turning the shank 36 into or out of the sleeve 16 so that the rearward end of the fulcrum bar 34 slides within the channel formed by the opposite side walls 18 of the handle 14.

A spring 38 is connected to the moveable jaw 24 at a spring anchor point 40 and at the opposite end to the interior of the handle 12. The spring 38 biases the moveable jaw 24 to an open position.

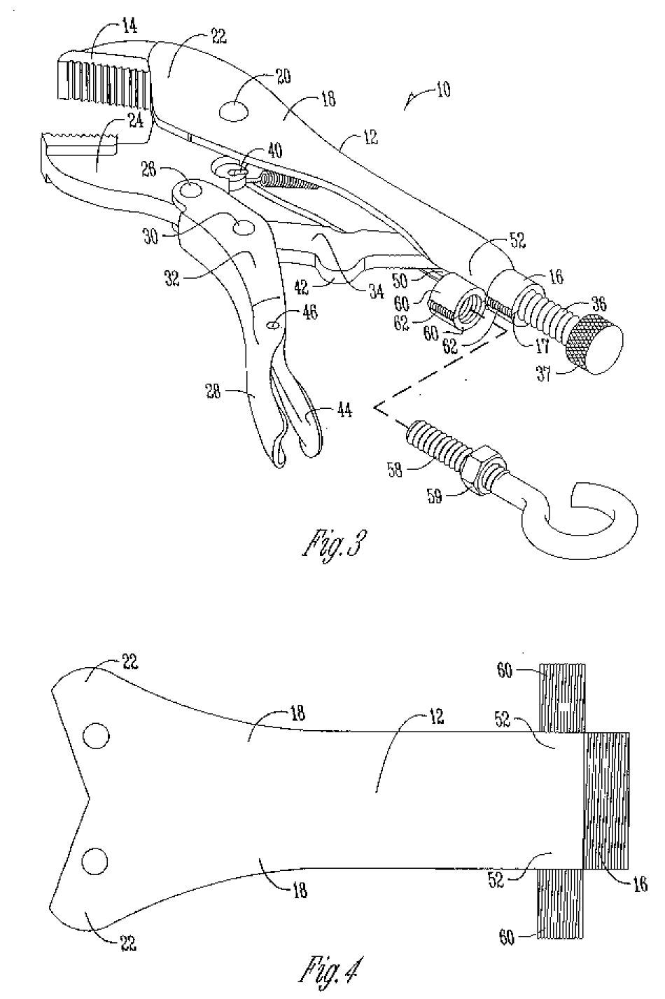

The fulcrum bar 34 has an intermediate lobe or lug 42 which engages the lever 28 when the pliers 10 is closed, as seen in FIG. 2. A release lever 44 is pivotally connected to the lever 28 by a pin 46. When the rearward end of the release lever 44 is squeezed toward the rearward end of the lever 28, the release lever 44 pivots about the pin 46 so that the forward end 48 of the release lever 44 pushes against the lobe 42 of the fulcrum 34 so as to release the pliers 10 from a gripping mode.

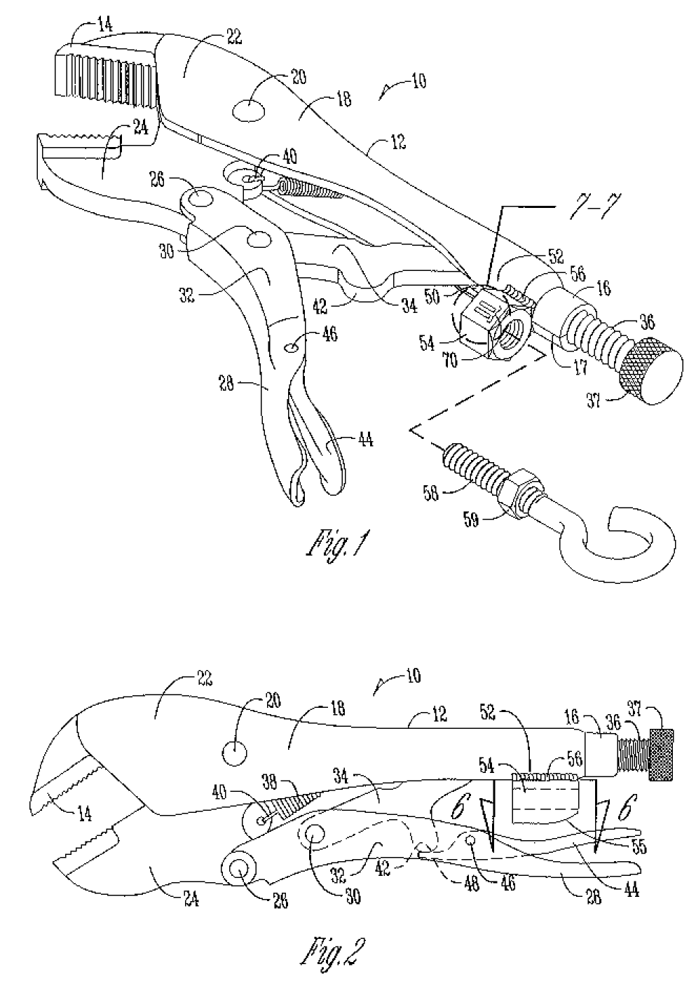

The above-described structure of the pliers 10 is conventional. The locking pliers 10 are improved in the present invention by the addition of an attachment member 54 having threaded port or aperture on the rearward end of the handle 12. As seen in FIG. 1, the attachment member 54 is in the form of a coupling nut or other extended wide nut welded on opposite sides to the rear flanges 52 of the handle 12 so as to overlay the longitudinal slot 50 extending between the handle flanges 52. Thus, the axis of the attachment member 54 is substantially parallel to the axis of the sleeve 16.

It is understood that the aperture 54 could also be formed by welding the coupling nut or other extended wide nut at any location around the rearward end of the handle 12 in an orientation parallel to the sleeve 16. It is noted that with the coupling or extended wide nut 54 welded to the inside of the handle 12, as shown in FIGS. 1 and 2, the axis of the aperture passes through the fixed jaw 14. Preferably, a weld 56 is provided on each side of the coupling or wide nut 54 and each side wall 18 of the handle 12, which precludes the sleeve 16 from being opened along the seam 17.

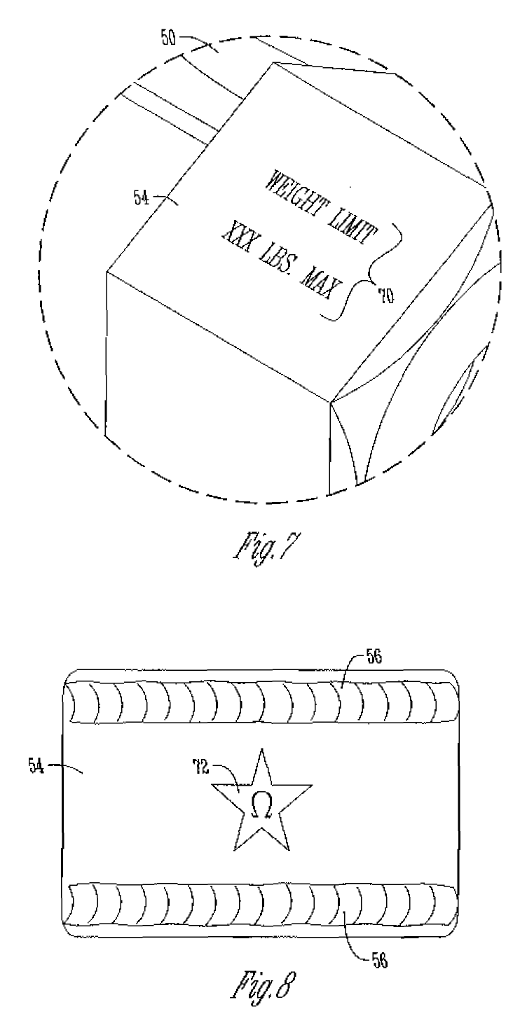

A threaded attachment rod 58 can be matably threaded into the coupling or extended wide nut 54. FIG. 1 shows the rod 58 to be in the form of a hook, although other forms may also be utilized which allow both pulling and pushing forces to be applied to the pliers 10 through the threaded connection of the rod 58 and the nut 54. As seen in FIG. 6, the nut 54 and the rod 58 do not interfere with the operation of the fulcrum bar 34 or the release lever 44. Thus, the pliers 10 are fully functional. If necessary, the rearward end of the attachment member 54 may be tapered or beveled so as to have a reduced diameter to assure that interference is avoided. The rod 58 is provided with a lock or jam nut 59 to tighten against nut 54 once the desired position of the pliers 10 is set, so as to lock the pliers 10 in the exact position.

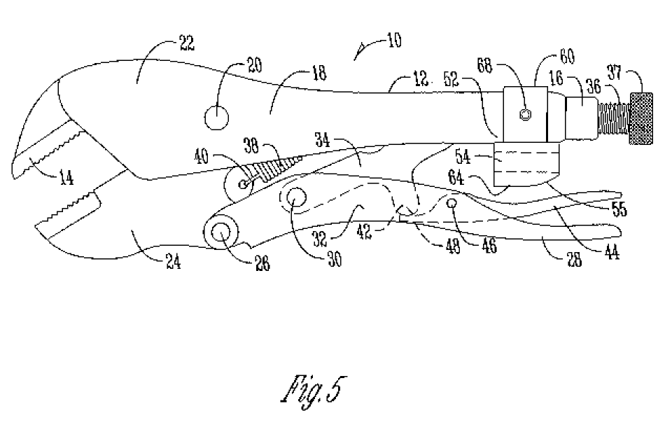

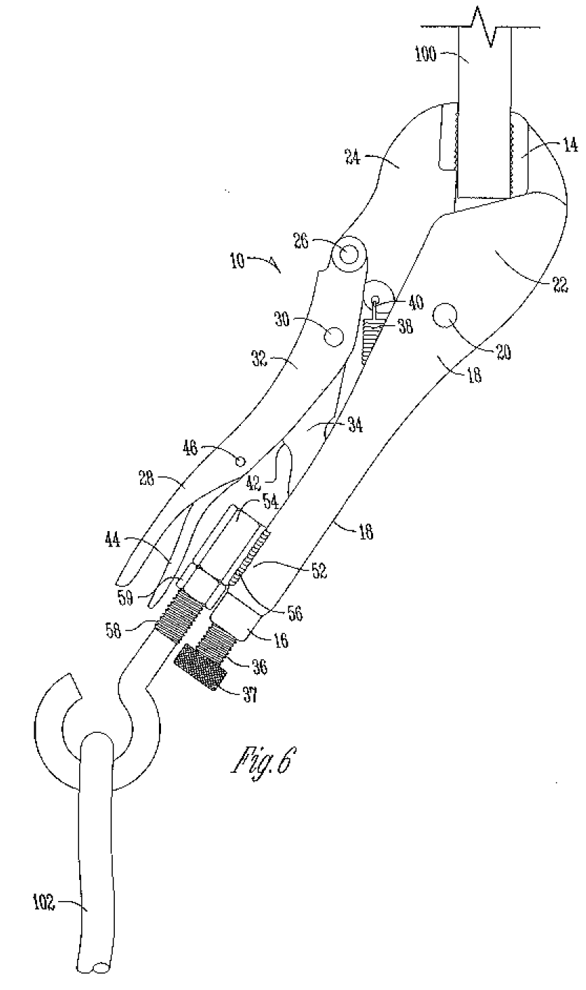

A second embodiment of the improved pliers 10 of the present invention is shown in FIGS. 3 and 4. In this alternative embodiment, the nut 54 is replaced with an attachment member formed by a pair of lobes 60 on the handle blank, such that the attachment member is integral with the handle 12 when the handle is manufactured. A weld 56 may be applied along the seam of the lobes 60 and along the seam 17 of the sleeve 16 so as to preclude spreading or pulling apart of the lobes 60 or the sleeve 16. The internal threads of the attachment member lobes 60 are adapted to receive the threaded rod 58, as described with respect to the first embodiment of FIGS. 1 and 2.

FIG. 5 shows a third embodiment of the present invention, wherein the attachment member is a threaded collar 64 retrofit onto the handle 12 by a band 66 slid over the sleeve 16 and 64 are adapted to receive the rod 58, as described above with respect to the embodiment of FIGS. 1 and 2.

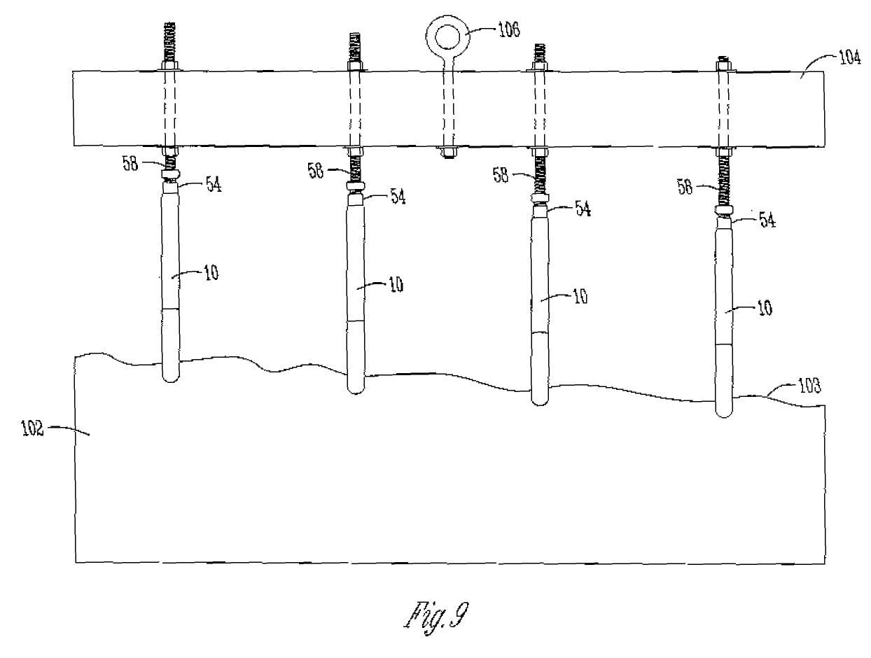

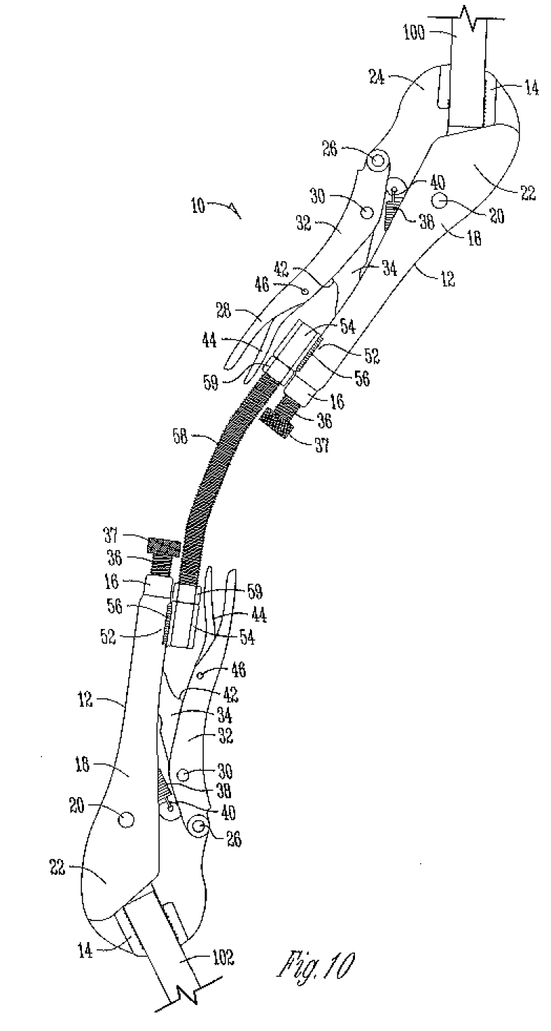

As seen in FIG. 7, the nut 54, lobes 60 or collar 64 which form the apertured attachment member may include text 62 regarding the weight limit for the pliers 10. Alternatively or additionally, the attachment member 54 may also include a name or indicia 64, as seen in FIG. 8, to identify a manufacturer for product liability purposes.

In use, the pliers 10 allow a pulling, pushing, twisting, or other force to be applied to the pliers 10 via the rod 58 threaded into the nut 54, lobe 60, or collar 64. Similarly, a pushing force can be applied through the axis of the nut 54, lobe 60, or collar 64 and a threaded attachment member or rod 58. As a further alternative, the locking pliers 10 can be locked onto a support, such as a beam 100, with a load 102 suspended from the opposite end of the rod 58, as seen in FIG. 6.

FIG. 9 shows multiple pliers 10 used to support a large work piece 102. The rod 58 is connected to the pliers 10 have different lengths to accommodate an uneven edge 103 of the piece 102. The rods 58 are bolted or attached to a bar or support beam 104 so that the piece 102 can be pulled, pushed or suspended to a desired position. While four pliers 10 are shown, it is understood that any number of pliers 10 be utilized in combination, depending on the size and weight of the load 102. An eye-bolt 106 may be provided on the beam 104 to lift the piece 102 via the pliers 10.

FIG. 10 shows a pair of pliers 10 according to the present invention which are interconnected by a rod 58, with one of the pliers clamped to a support beam 100 and the other pliers 10 gripping a load or work piece 102.

Thus, the threaded aperture connected to the handle 12 of the locking pliers 10, in the form of the nut 54, the lobe 60, or the collar 64, increases the versatility and applications for the locking pliers 10, including controlled movement, pulling, pushing, twisting, lifting and/or suspension of the pliers. Of course it is clear that the threaded aperture is used to connect threaded rod 58, but any appropriate attachment means such as a pin and hole, locking quick disconnect or locking twist shaft would be suitable as long as an attachment piece is firmly held in place during use.

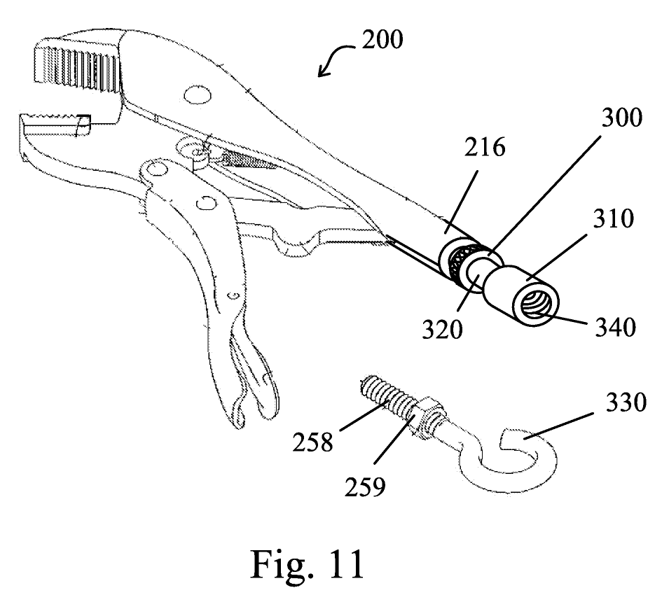

Referring now to FIG. 11, a locking pliers 200 is shown having a sleeve 216 formed as a channel to accept a threaded shank with knurled portion 300. Threaded shank 300 adjusts to control the jaw force as discussed above. An independently rotating shaft 320 is attached to threaded shank 300 to isolate rotational movement of an attachment member 310 when threaded shank 300 is adjusted. Attachment member 310 is threaded 340 to accept threaded insert portion 330. As discussed above, threaded insert portion 330 has threaded portion 258 and jam nut 259. In this orientation, no torque is produced in use because attachment member 310 and sleeve 216 are concentrically aligned.

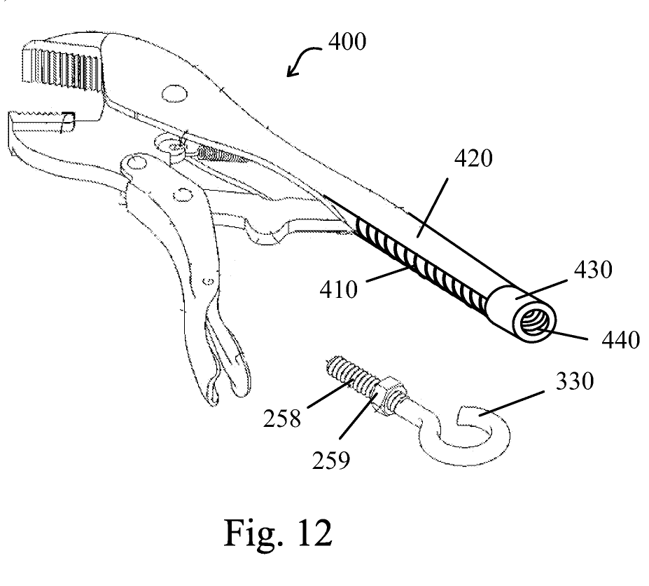

Now referring to FIG. 12, a locking pliers 400 is shown having a sleeve 420 formed as a channel to accept a self adjusting portion 410 and an attachment member 430. Attachment member 430 is threaded 440 to accept threaded insert portion 330. Again, as discussed above, this orientation also produces no torque because attachment member 430 and sleeve 420 are concentrically aligned.

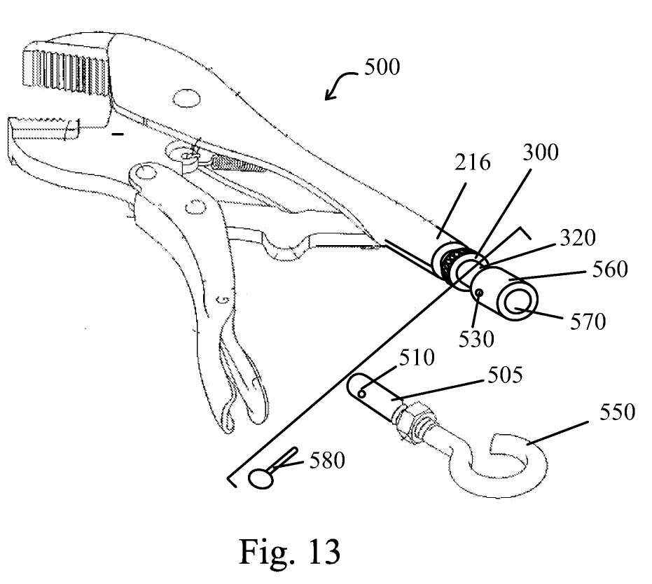

Referring to FIG. 13, a locking pliers 500 is shown having a sleeve 216 formed as a channel to accept a threaded shank with knurled portion 300. Threaded shank 300 adjusts to control the jaw force as discussed above. An independently rotating shaft 320 is attached to an attachment member 560 to isolate rotational movement of attachment member 560 when threaded shank 300 is adjusted. Attachment member 560 has an opening 570 to accept an insert member 550 and a locking pin hole 530. Insert member 550 has an insert end 505 and a locking hole 510. A locking pin 580 is inserted through locking pin hole 530 and locking hole 510 to lock insert member 550 securely in place during use. Of course other locking mechanisms are suitable and are known in the art such as but not limited to locking quick disconnect joints and a twist and lock channel or end. Again, as discussed above, this orientation produces no torque because attachment member 310 and sleeve 216 are concentrically aligned.

Although the instant invention has been described in relation to particular embodiments thereof, many other variations and modifications and other uses will become apparent to those skilled in the art.

What is claimed is:

1. A locking pliers assembly comprising:
a handle;
a first jaw coupled with said handle;
a second jaw moveably opposing said first jaw;
a locking lever coupled with said second jaw;
a release lever positioned between said handle and said locking lever and pivotally connected to said locking lever;
a bar coupled between said handle and said locking lever for locking said first and second jaws in a closed position; and
an attachment member concentrically disposed on an end of said handle being adapted to receive apply pulling and pushing forces to said handle.

2. The locking pliers assembly of claim 1 further comprising an insert member adapted to fit within said attachment member.

3. The locking pliers assembly of claim 1 wherein said handle further comprises a pair of handle flanges spaced apart whereby said attachment member is welded to each handle flange.

4. The locking pliers assembly of claim 1 wherein said attachment member is a threaded nut adapted having a longitudinal axis passing through one of said first and second jaws.

5. The locking pliers assembly of claim 1 wherein flanges of said handle each has a lobe to thereby form said attachment member.

6. The locking pliers assembly of claim 1 wherein said attachment member is marked with an indicator to indicate that said attachment member is original equipment to said pliers assembly.

7. The locking pliers assembly of claim 2 wherein said attachment member is a threaded collar adapted to couple said insert member to said locking pliers on a longitudinal plane passing through said first and second jaws to balance the forces therein.

8. The locking pliers assembly of claim 1 wherein said attachment member is marked with a load limit.

9. The locking pliers assembly of claim 2 wherein said insert member further comprises a hook end.

10. The locking pliers assembly of claim 1 wherein said handle further comprises a self-adjusting means for automatically adjusting the force applied between said first and second jaws.

11. The locking pliers assembly of claim 2 wherein said insert member further comprises a threaded end adapted to removeably fit within a threaded portion of said attachment member.

12. The locking pliers assembly of claim 2 wherein said insert member further comprises:
a pin end adapted to removeably fit within a pin receiving portion of said attachment member; and
a locking means to selectively hold said pin end within said receiving portion.

13. The locking pliers assembly of claim 12 wherein said locking means is a pin.

14. The locking pliers assembly of claim 2 wherein said insert member further comprises a custom end.

15. The locking pliers assembly of claim 12 wherein said insert member has an eye loop end.
